(19) United States
(12) Patent Application Publication
(10) Pub. No.: US 2006/0267730 A1
(43) Pub. Date: Nov. 30, 2006

(54) Apparatus and method for saving power in RFID readers

(75) Inventors: Kurt Ellis Steinke, Springfield, OR (US); Patrick Scott Watkins, Eugene, OR (US)

Correspondence Address: PSC SCANNING, INC. - STOEL RIVES LLP;C/O STOEL RIVES LLP, 900 SW 5TH AVENUE, SUITE 2600, PORTLAND, OR, 97204, US

(73) Assignee: PSC Scanning, Inc., Eugene, OR (US)

(21) Appl. No.: 11/139,234

(22) Filed: May 27, 2005

(51) Int. Cl. H04Q 5/22

(52) U.S. Cl. 340/10.1

(57) ABSTRACT

An apparatus and method for controlling and/or reducing power consumption in an electronic tag reader (e.g. RFID). One preferred method includes the steps of configuring an automatic inventory command for excluding features; adjusting a search order for singulating RFID tags; activating a trigger control of the RFID reader for engaging power to begin reading the RFID tags; having the poll the RFID tags at a frequency for identifying said tags and hop to another frequency when the RFID tags are not located; the reader then terminating the reading after an interval when there are no new tags or when other criteria are met without the user deactivating the trigger control.

### TECHNICAL FIELD

The field of the disclosure relates generally, but not exclusively, to electronic tag readers such as RFID readers and, more particularly, to an apparatus and method for reducing power consumption in such readers.

### BACKGROUND

The use of Radio Frequency Identification (RFID) transponders or tags to identify an object or objects is well known in the art of RFID systems. Typically, when these tags are excited they produce or reflect an electromagnetic wave at some frequency, which is modulated with an identifying code or other useful information. The tag may either be active or passive. Active tags have a self-contained power supply. Passive tags require external excitation when they are to be read within the detection volume of a reader. In passive tag systems, the interrogator or reader contains a transmitting/receiving antenna for sending an exciting frequency signal to the passive tag. The transmitting/receiving antenna is positioned at the reader's portal end for receiving a modulated signal (magnetic or electromagnetic) produced by the excited tag. This modulated signal identifies the tag and consequently the object attached thereto.

RFID systems are radio communication systems that communicate between a radio transceiver, called an interrogator and transponders or tags. In RFID systems, the interrogator communicates to the tags using modulated radio signals and the tags respond with modulated radio signals. When transmitting a message to the tag (called the downlink), the interrogator transmits a continuous-wave radio signal to the tag. The tag modulates the continuous-wave signal using modulated backscattering where the antenna is electrically switched, by the modulating signal, from being an absorber of RF radiation to being a reflector of RF radiation. This modulated backscatter allows communication from the tag to the interrogator (called the uplink). Conventional modulated backscattering systems identify an object passing into range of the interrogator and store data onto the tag and then retrieve that data from the tag at a later time.

Most interrogators are operated using a battery power system. The modulated backscattering systems consume a lot of power. As the number of tags to be identified increase, the consumption of power increases exponentially. Continual changing of the battery interrupts workflow and when the battery is low on power the interrogator may provide incorrect reads. Therefore, it is desirous to operate the RFID reader so as to prolong the life of the power supply.

U.S. Pat. No. 5,185,700 issued to Bezoes et al., entitled “Solid State Event Recorder,” teaches a processor-based data acquisition system. The system monitors platform operating conditions and uses telemetry transmitter units for transmitting data to receivers and a removable battery powered memory module. The limitations of this system include either reliance on the main power source of the mobile platform or continual monitoring of the memory module for a low power state. This system does not provide the means to save battery power for extended use.

U.S. Pat. No. 5,311,449 issued to Adams, entitled “Sterilizable Hand-Held Programmer/Interrogator,” teaches a medical interrogation device for data communication to a patient's defibrillator. This device is a processor-based unit that may either receive or transmit data to the defibrillator. This device has no power management system and is not able to conserve battery power.

U.S. Pat. No. 5,835,025 issued to Zufelt et al., entitled “Portable Battery Operated Power Managed Event Recorder And Interrogator System,” teaches a recorder and an interrogator that has a battery power source with a power regulator. The device automatically optimizes power through regulating and timing control. However, the amount of power savings in a battery is limited because the device regulates power consumption by controlling the pulse width which is a function of the length of an external trigger circuit.

The present inventors have recognized a need for an apparatus and method controlling and reducing power consumption for electronic tag readers.

### SUMMARY

In one embodiment there is a method of saving power in an electronic tag reader, such as a RFID reader, including the steps of configuring an automatic inventory command for excluding features; adjusting the search order for singulating RFID tags; activating a trigger control of the RFID reader for engaging power to begin a continuous sweep of the interrogator, that is painting the RFID tags; polling the RFID tags at a frequency for identifying the tags; hopping to another frequency when the RFID tags are not located; and terminating the hopping and painting after an interval when there are no new tags without the user deactivating the trigger control.

In another embodiment there is a data reader including an interrogator within the data reader for detecting data and a processor connected to an output of the RFID interrogator. The data reader may further include a feedback unit connected to the output and optionally a software and control circuit for configuring an automatic inventory command to exclude certain protocols and antennas and to terminate painting after a time interval.

These and other aspects of the disclosure will become apparent from the following description, the description being used to illustrate a preferred embodiment when read in conjunction with the accompanying drawings.

### BRIEF DESCRIPTION OF THE DRAWINGS

FIG. 1 is a diagrammatic view of a combined RFID system comprised of an RFID reader, optical code reader and data terminal according to a preferred embodiment.

FIG. 2 illustrates a simplified block diagram of the RFID system of FIG. 1.

FIG. 3 illustrates an input scheme of a program for the RFID system of FIG. 1.

FIG. 4 is a diagram of a RFID system illustrating a RFID reading field relative to a RFID tag.

FIG. 5 is a flow chart of a method of RFID feedback operation according to a preferred embodiment.

FIG. 6 is an illustration for an input scheme of an audio portion for the system of FIG. 1.

FIG. 7 is an illustration for an input scheme of report settings for the system of FIG. 1.

FIG. 8 is an illustration for an input scheme of read limits for the system of FIG. 1.

FIG. 9 illustrates the data terminal of FIG. 1 for a display of an image of a field of with a preferred RFID read zone interposed thereon.

FIG. 10 illustrates an enlarged image from the display of FIG. 9.

FIG. 11 illustrates a functional block diagram for barcode and radio tag reading in a preferred embodiment.

FIG. 12 illustrates a functional block diagram for tag reading by singulation in a preferred embodiment.

FIG. 13 illustrates a functional block diagram for tag reading by polling in a preferred embodiment.

### DETAILED DESCRIPTION OF THE PREFERRED EMBODIMENTS

While the preferred embodiments are described below with reference to RFID readers and tag, a practitioner in the art will recognize the principals described herein are viable to other applications.

A preferred embodiment is directed to apparatus and methods to lower power consumption in electronic tag readers, such as RFID readers, thereby conserving battery power. For example, power consumption may be lowered when automatically terminating a continuous sweep of the interrogator after an interval with no new tags found rather than waiting for a trigger release. In addition, the power consumption may be reduced in electronic tag readers by adjusting an automatic inventory command of a multi-protocol and/or multi-antenna RFID reader to be configured to exclude certain protocols, antennas, history and/or combinations thereof using an automated search algorithm. Also, power consumption may be reduced in RFID readers by adjusting the search order in which protocols, antennas, history and/or combinations thereof are used in a singulation of a multi-protocol and/or multi-antenna RFID reader. In another example, power consumption may be lowered in RFID readers by ceasing the polling of an RFID reader at a given frequency, hop to another frequency if no tags are identified or poll at increasing power levels until identifying the desired tag. The various methods may be implemented automatically selecting a software mechanism, that is, an algorithm. Also, some of the methods may be implemented manually by selecting a manual mechanism by the operator of the RFID reader. Furthermore, a switch may give an operator the ability to switch between implementing the software mechanism (algorithm) or implementing the manual mechanism (trigger) to implement the various energy saving methods for reducing power consumption in the electronic tag reader.

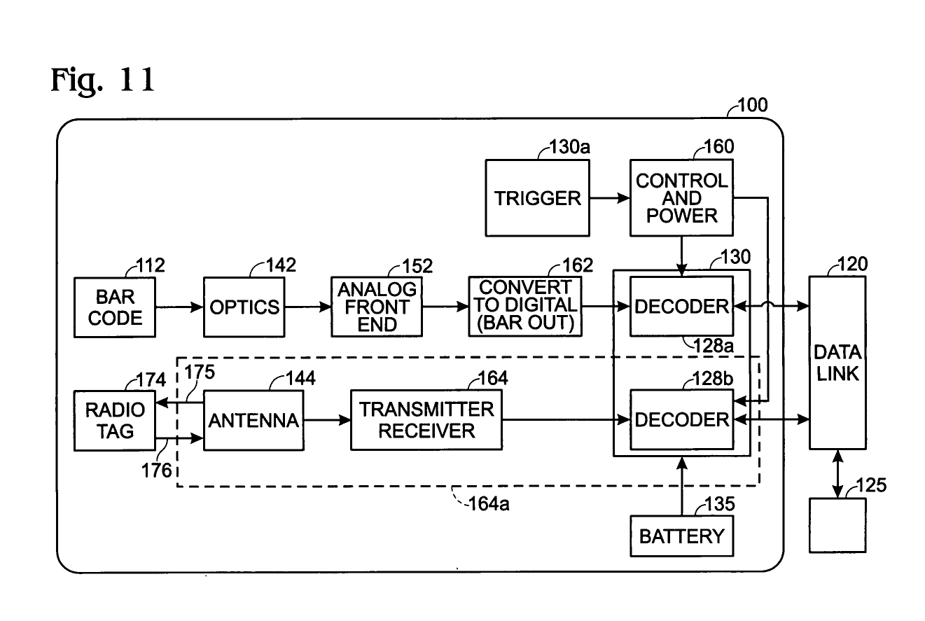

In a preferred embodiment as shown in FIG. 11, a multiple-technology data reader 100 includes an optics module 142 and analog front end components 152 for reading a bar code 172. The signal generated by the analog front end 152 is converted into a digital signal by an analog to digital (A/D) converter 162 which is connected to a device microcontroller 130. The data reader 100 further includes an antenna 144 wherein a modulated RF signal 175 is sent to a RFID tag 174 and the RFID tag 174 transmits a backscatter signal 176 back through the antenna 144. The transmitter/receiver 164 component of a RFID interrogator 164a sends and receives, respectively, the RF signal 175 and backscatter signal 176. The transmitter/receiver 164 and interrogator 164a are connected to the device microcontroller 130. The microcontroller 130 includes a decoder and control interface 128a for the bar code reader and another decoder and control interface 128b for the RFID reader. The decoder and control interfaces 128a and 128b are connected to a device communications control and power unit 160. The multiple-technology data reader 100 also includes a trigger unit 130a which initiates the control and power signals, both to and from the device communications control and power unit 160 on the microcontroller 130. The microcontroller 130 is connected to a host computer 125 via USB link 120, or other interfaces. One such multiple-technology reader is described in U.S. Pat. No. 6,415,978, issued to McAllister, entitled “Multiple Technology Data Reader For Bar Code Labels And RFID Tags,” the entire contents of said patent are incorporated herein by reference and made part of this disclosure. This reader may use the principles of the preferred embodiment.

The reader device interface 128a has input/output endpoints which enable the host computer 125 to use a default control that will initialize and configure the reader device interface 128a. The input/output endpoints allow the host computer 125 to send data to the reader interface 128a. Furthermore, the reader device interface 128a may send data to the host computer 125. The data may be sent in both directions, between the reader device interface 128a and the barcode reader subsystem, via a serial communications line.

Likewise, reader device interface 128b has input/output endpoints which enable the host computer 125 to use a default control that will initialize and configure the reader device interface 128b. The input/output endpoints may send data to the reader device interface 128b. Conversely, the reader device interface 128b may send data to the host computer 125. Data may be sent between the reader device interface 128b and the barcode reader subsystem, in either direction, via a serial communications line or data bus.

The trigger 130a may be used to adjust the RF power transmitted by the RFID reader 100 relative to a single RFID tag of interest. That tag may be singulated with its individual identity read, even though more tags may be present within the normal read volume of the RFID reader and its antenna 144. Alternately, a singulation algorithm or singulation scheme may select the tag of interest. In other words, other nearby tags are excluded through singulation. For example in a singulation scheme, if an initial trigger 130a pull results in transmission 6-10 decibels below the maximum allowed power, then as the trigger 130a remains activated it uses a power level that is 1-2 decibels greater than the previous read. The amount of power increase depends on the power level step provided by the module design. When the trigger 130a is released, the reading of a RFID tag stops. If the maximum power level is reached before the trigger is released then the reading of an RFID tag stops automatically. Alternately, a singulation algorithm may identify the tag of interest by way of a packetized manner where a single packet contains a complete command from a reader and a complete response from a tag.

When the trigger 130a energizes the RFID reader 100, singulation would give a high probability of initially reading only those tags that are in close proximity to the antenna 144, that is, directly ahead of the antenna. As RF transmitting power increases, the read volume grows steadily up to the maximum that a particular RFID reader permits. The singulation algorithm provides a better restriction of the read zone than does, for example, a tight (narrow) antenna beam. In addition, the singulation algorithm does not require a change from a typical trigger 130a mechanism or a switchable antenna. Alternately, it might be desirable to have a software switch, that is, a dialog box or the like. The singulation may be selectable by using a long trigger pull, a double-click on a trigger, a quick release of a trigger, software menu selection or automatic algorithm selection.

In addition, there may be software with a particular configuring algorithm or preselection mechanism for configuring the automatic inventory command of a multi-protocol and/or multi-antenna reader to be configured to exclude certain features, such as protocols and antennas and/or combinations thereof. Many applications will not read the full range of tag types or orientations when singulated. Consequently, automatically excluding features, such as protocols, antennas and/or combinations of protocols and antennas, by using an automated search algorithm in the RFID reader 100 will save considerable battery 135 power. Alternately, certain features, such as protocols, antennas and/or combinations thereof may be manually activated by the operator of the RFID reader. Once certain features like protocols, antennas and/or combinations thereof have been excluded, the automatic selection of the singulation scheme may occur by prefacing the read sequence with a single low-power read just sufficient to read a tag touching the antenna. Once such singulation method is described in U.S. patent application Ser. No. 11/055,960, entitled “RFID Power Ramping For Tag Singulation,” the entire contents of said patent application are incorporated herein by reference and made part of this disclosure, wherein the reader may use the principles of the preferred embodiment as described in this disclosure.

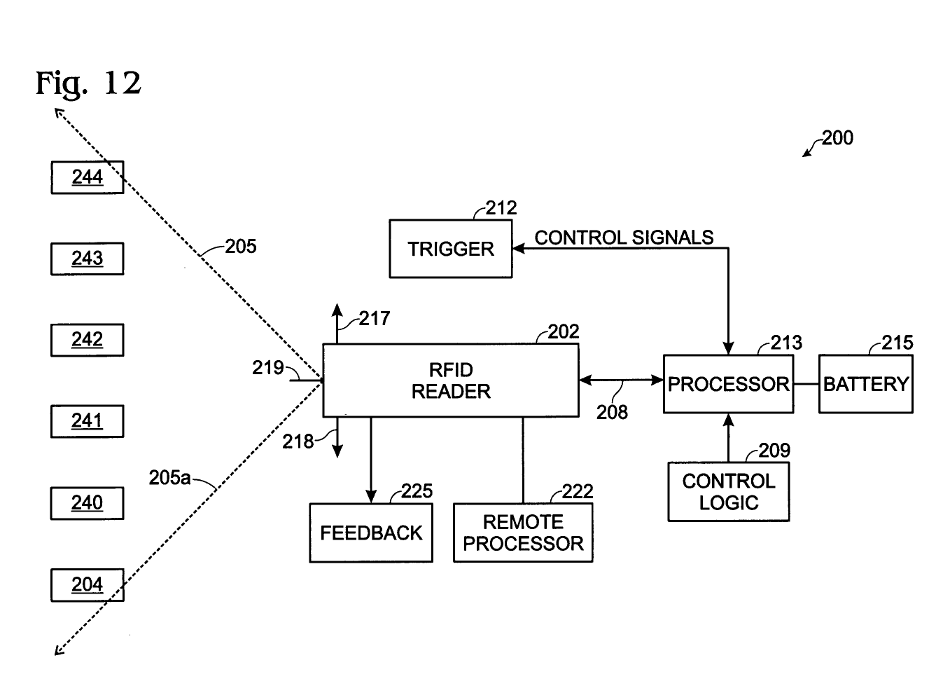

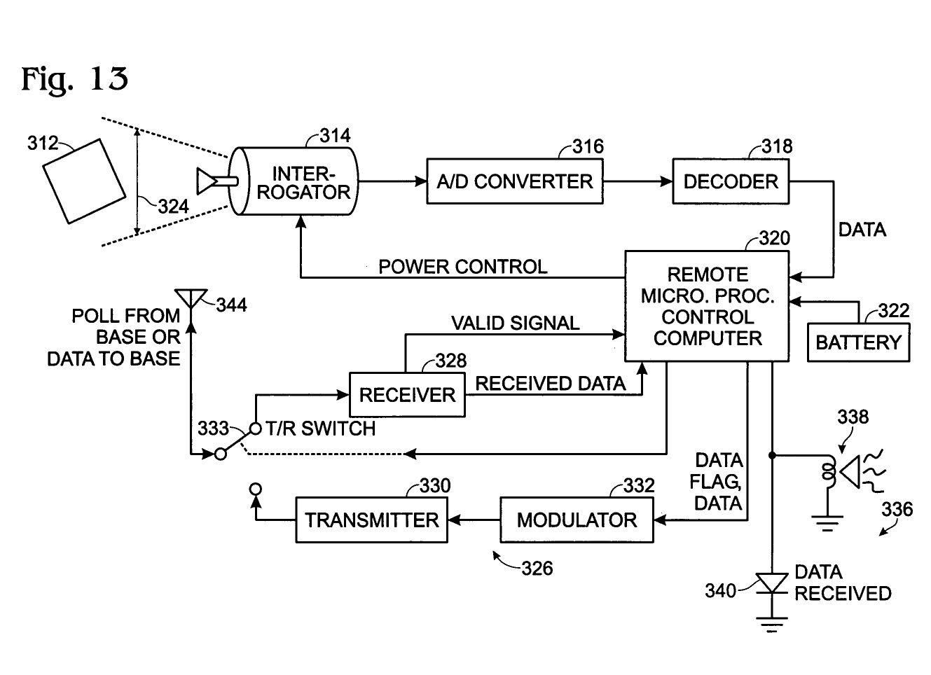

In FIG. 12, RFID apparatus 200 illustrates a block diagram of a preferred embodiment. The apparatus 200 uses a RFID reader 202 to interrogate a particular RFID tag(s) in a plurality of RFID tags, including but not limited to, 204, 240, 241, 242, 243 and 244. The RFID apparatus 200 may be a handheld RFID reader 202, wherein the RFID reader 202 passes over the RFID tags 204, 240, 241, 242, 243 and 244. Alternately, the RFID reader 202 is substitutable for a fixed reader, wherein RFID tags 204, 240, 241, 242, 243 and 244 are passed in front of the reader. The RFID reader 202 may be connected via a USB link 208 or other interfaces to processor 213. The interface link may be hardwired to an infrared modem connection, an RF modem connection, a combination of connections or other suitable connections. In addition, there may be software with a particular configuring algorithm as part of the processor 213, or a preselection mechanism that is manually activated for configuring an automatic inventory command of a multi-protocol and/or multi-antenna reader that will exclude certain features like protocols and/or antennas or combinations thereof. Many applications will not read the full range of tag types or orientations when singulated. Consequently, automatically excluding features, such as protocols, antennas and/or combinations of protocols and antennas, by using an automated inventory command search algorithm in the RFID reader 202 will save considerable battery 215 power.

RFID reader 202 may also include a self-contained micro-processor and be capable of storing data, and may or may not interface with a remote processor 222. Processor 213 receives control input from a control logic circuit 209 for communication with RFID reader 202. The control logic 209 may be programmable and part of processor 213 or may be separate. An activation switch, such as trigger 212, provides control signals and power to processor 213. Consequently, the switch may implement a singulation scheme to locate a particular RFID tag, for example, tag 241 from amongst RFID tags 204, 240, 241, 242, 243 and 244. As another feature of the automated inventory command, the software and control circuit located within the microprocessor 213 may maintain a count of the number of RFID tags found per each singulation attempt. The count may be at each protocol and/or antenna and may automatically exclude certain protocols, antennas and combinations thereof using an inventory algorithm based on that history which will reduce using power from the battery 215. Also, a bar code scanner may use the principles of the preferred embodiment as described in this disclosure. One such bar code scanner that provides bar code image signals by using a digitizer circuit is described in U.S. Pat. No. 5,864,129, issued to Boyd, entitled “Bar Code Digitizer Including Voltage Comparator,” the entire contents of said patent are incorporated herein by reference and made part of this disclosure.

The power-density-time (PDT) control that provides a ramped power control is accomplished by use of a singulation trigger 212. The singulation may begin when the trigger 212 is pulled and held. The read may continue for as long as the trigger 212 is held, up to the point of maximum power. Depending on what RFID tag is to be identified from the tags 204, 240, 241, 242, 243 and 244, the trigger 212 would be pulled to generate a transmitter power. The transmitting power would provide the desired sensing volume between 205 and 205a using antenna 219, wherein a particular tag is identified from among the tags, 204, 240, 241, 242, 243 and 244. Furthermore, the software configuring algorithm located within the microprocessor 213 containing an inventory command algorithm that excludes certain features, such as a variety of protocols, antennas and/or combinations thereof, and will significantly reduce the power consumption on the battery 215. The reduced power consumption is a result of improved response time in using the singulation scheme when there are less RFID tags to be searched among a group of tags.

In addition to trigger 212, the RFID reader 202 may optionally include a feedback mechanism 225. One such mechanism may comprise a progress bar on a LCD increasing as the transmitting power increases. This feedback allows the user to judge whether or not the read effort is successful because a singulation read may take longer than a normal read. Alternately, the feedback mechanism 225 device may comprise an auditory feedback that generates an audible signal when a RFID tag is read or when maximum power is achieved. This auditory feedback may include, but is not limited to, increasing a pitch sequence of tone-beeps working with the transmitter power. Power consumption on the battery 215 is reduced because the user having a feedback mechanism 225 will have a more effective way to operate the RFID reader 200.

Using RFID apparatus 200 from FIG. 12, singulation may also be accomplished by a method that first directs the antenna 219, which encompass a volume when oriented in the direction of the arrows 217 and 218 and may include a tag 242. Next, a user of reader 202 activates the trigger 212 issuing a read attempt at low RF transmitting power. If the RF power is sufficient for the tag 242 to respond, the tag 242 responded because the read volume was large enough (power level) to enclose the target tag. For example, for only tag 242 to respond, the RF power must be at a level so that a volume that is between 205 and 205a is a size that may include tags 204, 240, 241, 243 and 244, but must include tag 242. If tag 242 is detected, the RFID reader 202 will issue no more reads until the trigger 212 of the RFID reader 202 is operated by the user. Alternately, battery 215 power may be conserved by automatically terminating the singulation through the software and control circuit when using a polling algorithm after an interval or some number of polls with no RFID tag found. The tag information is then presented to the user or to the processor 213. Likewise, the principles of the preferred embodiment may be used in U.S. Pat. No. 6,024,284, issued to Schmid et al., entitled “Wireless Bar Code Scanning System,” the entire contents are incorporated herein by reference.

If the RF power is not sufficient for a tag 242 to respond or the volume is not large enough that it encloses tag 242, then the RFID reader 202 issues read attempts increasing RF power. That is, the read volume increases until tag 242 is read. When tag 242 is detected, the RFID reader 202 will automatically issue no more reads, saving power from battery 215, and then the reader 202 will present the tag 242 information to the user or the processor 213. The RFID reader 202 will power down after the desired tag is detected and the information is presented to the user or the processor 213.

In FIG. 13, there is shown a typical RFID reader 300 interrogating a RFID tag 312, which may be attached to an item to identify that item. The data representing the item is obtained by a terminal such as an interrogator 314. The interrogator 314 receives a backscatter signal from the tag 312 which is digitized as by an analog to digital converter 316. The digitized signal is transmitted to the decoder 318 to provide serial binary data representing the RFID tag backscatter signal. This data is inputted into a microprocessor controller 320 in the remote unit. The controller 320 exercises several functions. These functions include, but are not limited to, a control signal generation for enabling the interrogator 314 to read across the tag in a volume as depicted by the arrow 324 when the tag 312 comes into proximity of the interrogator.

The wireless radio communications features are provided by a transceiver 326 including a receiver 328, a transmitter 330 and a modulator 332. The transmitter 330 and the modulator 332 may provide transmission where a carrier is moved between states, according to different binary bits of a message. For example, the output frequency in an embodiment of the invention may be in the ultra-high frequency (UHF) band, in the very high frequency (VHF) band or another band at a relatively low power. In typical applications such as in warehouses and factories, low power transmitters are sufficient to cover a large enough area for remote collection of data from RFID tags.

The receiver 328 may operate at the same frequency as the transmitter 330. The receiver 328 and the transmitter 330 are connected to an antenna 344 using a transmit/receive (T/R) switch 333, which is controlled by a control signal from the controller 320. The messages are either data or data flag when the remote unit is ready to transmit to the base station. Polling messages from the receiver 328 constitute received polling data and are also inputted into the control unit 320. The receiver outputs a valid signal (a level which may be one polarity rather than another or ground) to the controller 320 when the strength of the received signal is sufficient (amplitude and duration) to distinguish it from noise. The received data is not utilized without the valid signal output being of a proper level. The controller 320 provides data or flag data message response to the modulator 332. It operates the T/R switch 333 to a transmit position so that the response message can be transmitted to the base station.

The base station also provides polling messages addressed to the remote unit to acknowledge the receipt of valid data messages. The control unit 320 operates an annunciator 336, which may include an audible signal generator and speaker 338 and a data received indicator light emitting diode (LED) 340. In this embodiment, the antenna 344 provides greater communication distance or a reduction in “multi-path” interference for greater reliability.

Since the polling cycle of an RFID reader 300 is relatively short, that is about 0.1 sec, the transmitter 330 duty time may be reduced below 100% when painting, that is, sweeping the RFID reader to read continuously while the trigger is held down. Alternately, when painting the RFID reader is actuated by a single trigger pull, with the reader continuing to read multiple RFID tags in the read zone as long as the trigger is held until a terminating event occurs. In another embodiment when painting, there is real-time feedback of the progress of a multiple RFID tag reading operation. Painting will reduce power consumption of the power supply 322 (battery) with little or no reduction in the responsiveness or the number of RFID tags found. A considerable amount of battery 322 power may be conserved by automatically terminating painting after a time interval or some number of polls with no new RFID tags found. The battery 322 power is wasted by polling with no tags in the field. Consequently, it is beneficial to automatically cease the inventory command through the use of software and control circuit in the controller 320. The inventory command would cease using a polling algorithm if no new tags are found or if data collisions are not detected after a specified number of successive attempts at different frequencies. Furthermore, multipath reflections of the interrogator signal cause local peaks and nulls which affect the signal strength received by the tags. The automatic inventory command may have a function wherein the reader will reduce the interception of the multipath reflections. Reducing multipath reflections improve the RFID reader processing time which reduces the consumption of power.

Power from the battery 322 may be saved by ceasing polling at a given frequency and hopping to another frequency if no tags are identified or if data collisions are not detected at the given frequency. Frequency hopping may be accomplished through the use of software with a frequency hopping algorithm and a control circuit in the controller 320. Finally, power from the battery 322 may be conserved by reading at the lowest possible interrogator 314 output and then polling at increasing power levels using a polling algorithm until a tag is read through singulation.

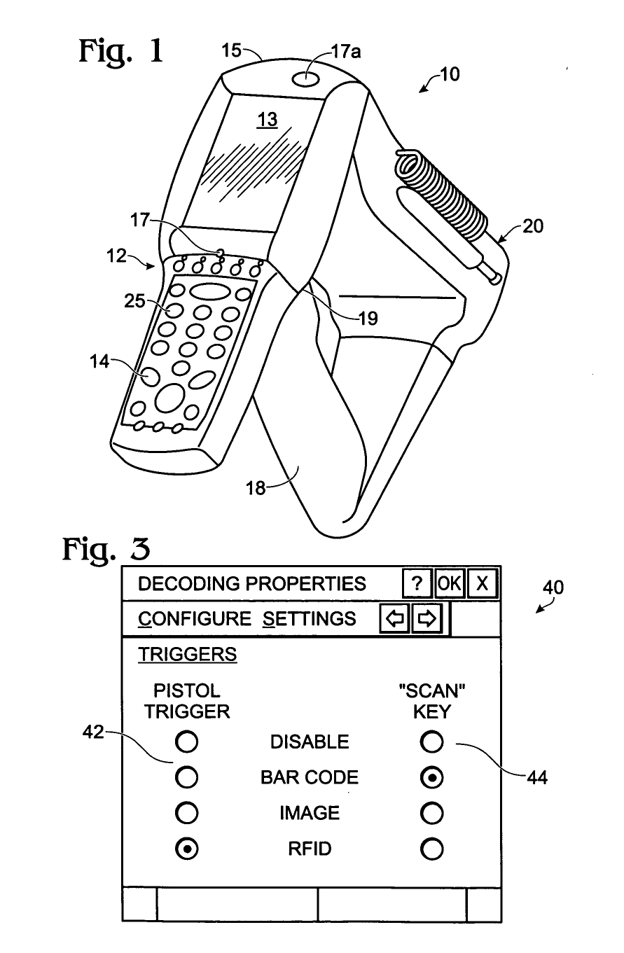

FIG. 1 illustrates a handheld combination device 10 comprising a portable terminal section 12, a handle section 18 and an RFID antenna section 20. The portable terminal section 12 includes a touch display screen 13 and a keypad section 14 for providing control or data input into the terminal or visual display. The terminal 12 includes a front window 15 through which a data reading device such as an interrogator to read RF backscatter signals from a tag. The reader 10 is preferably a combination system with the various functions controlled by the terminal 12. Input is entered into the reader 10 by using the touch display screen 13 or keypad 14. Within a particular mode of operation, the user may activate a particular read operation by actuating a trigger 19 or a scan key trigger 25. The trigger 19 is located on the front of the handle 18. The scan key trigger 25 is located on the keyboard 14. In addition, another virtual switch may be used on the touch display screen 13 to activate a read operation.

During a read operation in response to a trigger 19 pull, the reader 10 sends out an interrogation signal. Upon receipt of the interrogation signal a RFID tag may respond by sending out a modulated backscatter signal containing the tag data information. The RFID reader then senses the modulated backscatter signal and processes the signal to obtain the data.

Typically, an RFID read operation in a handheld device uses a trigger 19 pull and a single read command sent to the reader 10 to read all tags within the RF field. The RFID reader 10 may read multiple tags within a single read operation or tag inventory operation. The tags seen in a given read operation are read sequentially according to a suitable protocol such as a query response protocol or an air interface protocol (AIP). In addition, the software configuration algorithm or preselection mechanism in terminal 12 may have an inventory command of a multi-protocol and/or multi-antenna reader to be configured to exclude certain features, such as protocols, antennas and/or combinations thereof. The inventory command may also have an automated search algorithm to exclude such protocols and/or antennas. Considerable power will be saved since the power consumed is the product of the power per inventory sequence times the number of protocols times the number of antennas.

It is known in the art that all RFID tags in a read volume are not always successfully read during a single read operation. In a first preferred embodiment, the RFID read operation is extended beyond a single read attempt by continuing multiple interrogation sequences that are undertaken until meeting a terminating criterion. This consumes significant amounts of power. Various methods of saving power in an RFID reader using software mechanisms that initiate various algorithms or manual mechanisms (e.g., manually pulling the trigger on the electronic tag reader with various pulls initiating manually the various methods) include: (1) configuring an automatic inventory command for excluding certain features, such as protocols and antennas or combinations thereof; (2) activating a trigger control of the RFID reader to engage power to begin sweeping the RFID reader to read continuously while the trigger is held down, that is, painting the RFID tags; (3) adjusting a search order to singulate the RFID tags; (4) polling the RFID tags at a first frequency for identifying the RFID tags; (5) hopping to another frequency, one or more times, when the RFID tags are not located; (6) terminating the hopping and the painting after an interval when there are no new tags without deactivating the trigger control on the terminal unit 12; and 7) combinations of two or more if the above methods.

In another embodiment, the RFID read operation is extended beyond a single read attempt by sweeping the RFID reader to read continuously while the trigger is held down, that is painting. One such painting method may be directed to a handheld reader including the steps of (1) pointing a handheld RFID reader toward a read area; (2) actuating a trigger on the handheld RFID reader to commence reading RFID tags by the substeps of (a) performing a first read operation, wherein the read operation comprises interrogating and singulating one or more RFID tags in the area, (b) continuing with a subsequent read operation comprising reading one or more tags in the read area, and (c) the RFID reader discontinuing subsequent read operations once meeting a termination criteria.

There are various mechanisms and methods for use at the time of activating the trigger, before activating the trigger and/or termination of operation of the RFID reader 10. For example, the activation criteria may include reducing the transmitter duty cycle below 100% when painting. The reducing of the duty cycle will reduce power consumption while there is no reduction in the responsiveness of the RFID reader or in the number of RFID tags found in a sense volume. Termination criteria may include using software and a control circuit wherein an algorithm will automatically terminate painting after a time interval or some number of polls with no new RFID tags located. This will reduce power consumption rather than waiting for the user of the RFID reader to recognize that no new RFID tags are found and then releasing the RFID reader trigger. Many RFID interrogations will not see the full range of RFID tag types and orientations. Therefore, before activating the trigger criteria may include allowing the inventory command of a multi-protocol and/or multi-antenna to be configured to exclude certain features, such as protocols, antennas and/or combinations thereof. The inventory command would use an automated search algorithm in the software and control circuit maintaining a count on the number of RFID tags found per each RFID interrogation at each protocol and antenna. In addition, the software may automatically exclude certain features such as protocols, antennas and/or combinations thereof, using the inventory algorithm based on history. Excluding either protocols and/or antennas will reduce power consumption and improve response time.

The software may use various mechanisms or algorithms automatically selecting features to reduce power consumption. In one method the system would have knowledge that a predetermined number of RFID tags are expected in a particular read operation. For example, when reading a pallet of items in a warehouse, the system might know that 50 RFID tags are expected to be located on each pallet. Once all of the 50 RFID tags are read the operation is terminated. In addition, the pallet itself may have a RFID tag that contains information as to how many items are on the pallet. Alternately, the information may be stored in a look-up table accessible to the reader terminal 12. Once the pallet RFID tag is interrogated, the terminal may access the lookup table and obtain the number of RFID tags that are expected to be on the pallet.

There are other software algorithms or mechanisms to reduce power consumption. Transmitting power may be conserved by interrogating a RFID tag at the lowest possible transmitter power and then increasing the transmitter power when using singulation and/or polling techniques. Multipath reflections cause local peaks and nulls which affect the signal levels received by the interrogator. Power may be saved by ceasing polling or singulation at a given frequency and then hopping to another frequency if no RFID tags are identified or if a data collision is not detected. In addition, power is wasted by polling with no tags in the field. Therefore, power consumption may be reduced with a software mechanism ceasing the inventory command if no new tags are found or if data collisions are not detected after a specified number of attempts at different frequencies. Also, power consumption may be reduced by the inventory command feature of counting the number of RFID tags found when interrogating at each protocol and/or antenna, and automatically adjusting the search order in which the protocols and/or antennas are used in singulation and polling.

All of the software mechanisms may be programmable variables or configured, that is selected variables, by the user of the RFID reader 10. For example, the user may select software that may examine an intermediate report of tag data received following a given criteria and decide to terminate the read operation. Thus, there is a reduction in power consumption. The automatic termination of the read operation is quicker than what is manually done by the user of the terminal 12 when finally the user realizes the read operation is over and releases the trigger 19.

In another embodiment the software mechanism or algorithm allows the user to move the interrogator in a single sweep while the trigger is continuously actuated. Since the polling cycle of the RFID interrogator is about 0.1 sec., the transmitter duty cycle may automatically reduce the duty cycle to some point below 100%. The polling algorithm reduces power consumption while maintaining responsiveness of the interrogation. For example, when the user moves the interrogator across a sensing volume the operation may try to read all the RFID tags. By moving the interrogator the user may relocate the direction of the antenna so as to better locate and read RFID tags. This increased sensitivity coupled with the software mechanism automatically reducing the duty cycle provides for a reduction of power consumption.

The energy saving mechanisms may be applicable to other electronic tag systems such as combined RFID/EAS tag systems or other wireless electronic tag systems, and combined RFID and optical code readers. These energy saving mechanisms described in this disclosure may also apply to a system as disclosed in U.S. application Ser. No. 09/597,340, hereby incorporated by reference. The EAS circuit is integrated into the circuitry of the electronic item.

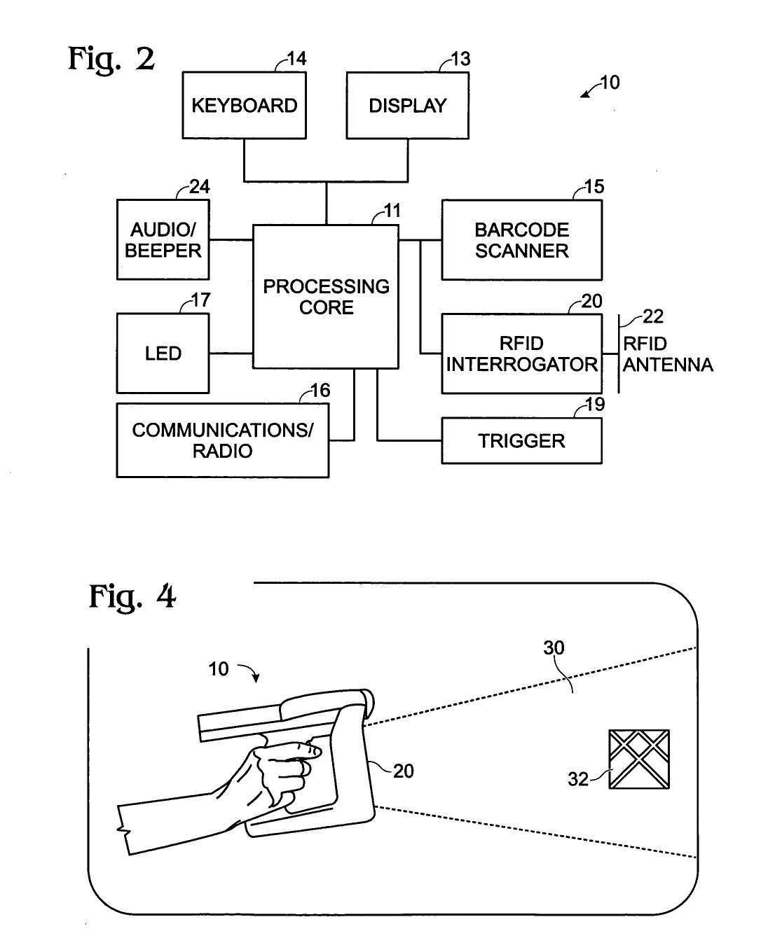

FIG. 2 illustrates a schematic of the components of the combined reader 10 of FIG. 1. The reader 10 includes a processing core 11 which may comprise the microprocessor within the terminal 12. Attached to the processor core 11 are the keyboard 14 which provides the information input and the display 13. The display 13 shows information and may act as a touch display screen for inputting commands or data into the system. Within the control of the processing core 11 the system has two indicators audio/beeper 24 and an indicator light 17. The indicator may comprise a LED or other suitable visible light indicator. Alternately, the indicator 17 may be any electro-mechanical means including, but not limited to, a separate high-intensity LED or a suitable indicator appearing on the display 13. Furthermore, the reader 10 has multiple input devices such as a barcode scanner, imaging reader 15 or RFID interrogator 20. Connected to the interrogator 20 is the antenna 22 whereby the system communicates with RFID tags. Connected to the communication radio is an antenna whereby the system communicates to a computer or a host via a land-line or wireless communications 16.

The display 13 provides a versatile and convenient control interface for the reader 10. In a preferred operation, the user may select which of the reading mechanisms to be used and configure an automatic inventory command for excluding certain protocols and/or antennas. The reader 10 includes two triggers, namely the pistol trigger 19 on the handle 18 and the scan key trigger 25 on the keyboard 14 of the terminal 12. The user may then activate the trigger control, either pistol trigger 19 or the scan key trigger 25 on the RFID reader, to engage power to begin painting RFID tags. The user may adjust the search order of the protocols, antennas and/or combinations thereof for singulating the RFID tags whereby power consumption is reduced and response time is improved. Alternately, the adjusting of the protocol and antenna search order may be performed automatically or prior to activating the trigger control by using adjusting mechanisms in the singulation algorithm software.

In one operating scheme, the terminal operates in a Microsoft Windows™ environment. Once the unit is powered on, onscreen instructions are used to calibrate the touch screen 13. Accessing the configurations settings, a set of trigger options become available as shown in the display 40 illustrated in FIG. 3. Several configurations may be available including, but not limited to protocols and antennas. For example, when the RFID option is engaged under the column pistol trigger 42, the user activates the trigger in a push mode that the system software may automatically enable or disable certain antennas that allow the RFID interrogator 20 to more quickly identify a particular RFID tag or tags. Alternately, under the scan key 44 a bar code may be engaged providing optical code information. A multitude of combinations are available using the reader 10 including disable and image.

Once the reader 10 has been configured, the protocol and antenna search order adjusted for singulation and the trigger control activated the user may begin polling the RFID tags. An application is opened on the terminal 12 that accepts data in a suitable format as received from RFID tags such as, for example, keyboard wedge data which is accepted by Microsoft Wordpad™ program. During the polling operation the front LED 17 turns orange indicating that the RFID interrogator 20 is in operation. The device sounds an audible beep as the tags are read. The RFID read is entered into the application. When the read no longer identifies any tags or a certain time interval has elapsed, the software mechanism automatically hops to another frequency. Frequency hopping continues until a desired number of RFID tags have been identified or some other criteria programmed into the software inventory command algorithm. Once all of the desired RFID tags have been found, the inventory command algorithm automatically terminates painting after a time interval when there are no new tags. The termination of the painting is accomplished without deactivating the pistol trigger 19 or the scan key trigger 25.

FIG. 4 illustrates a preferred orientation for aiming the system 10 and an RDID tag 32 such that the RFID section 20 points directly at the tag 32 providing a read field 30 encompassing the tag.

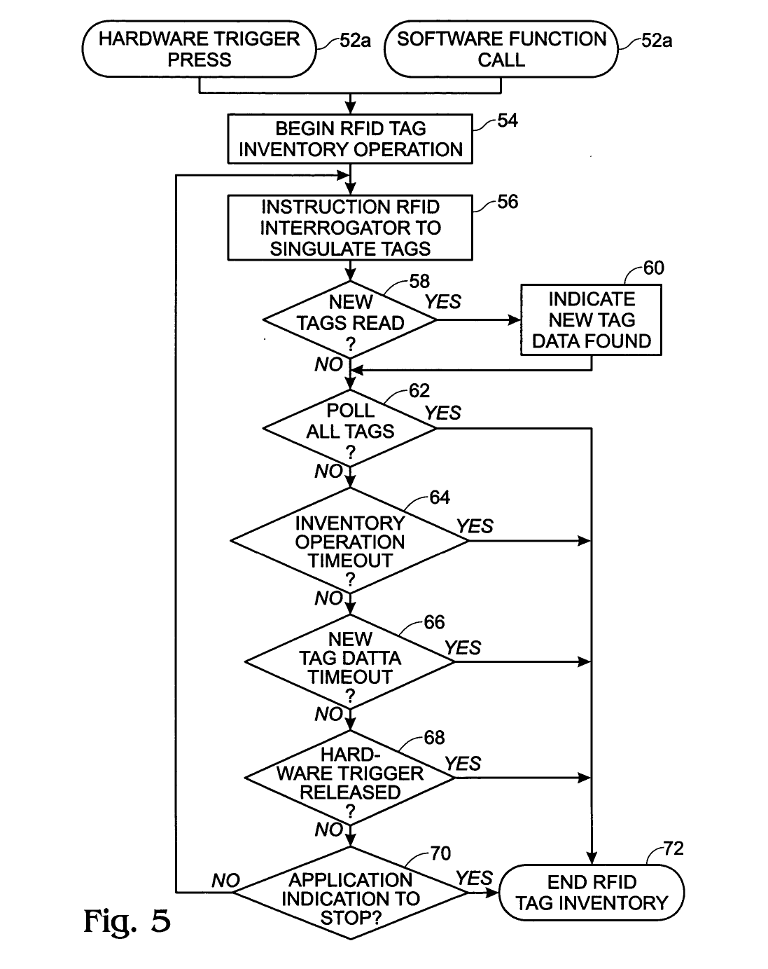

FIG. 5 illustrates a flow chart of a preferred method 50 for saving power in a RFID reader as described in the following steps. In the most common configuration, the protocols and/or antenna are preselected or engaged prior to starting the trigger pull at 52a. Alternately, the system may start by a hardware trigger pull at 52a to automatically configure the protocols and/or antennas. After configuring the protocols the system may be activated by a hardware trigger push to engage power to begin painting RFID tags. However, the user may start via a signal from an operating and/or software protocol at 52b. At 54 the RFID inventory command may be commenced. In this operation software will automatically adjust the search order of the system protocols, antennas and/or combinations thereof in order to singulate tags at 56. In this step, the RFID interrogator emits a signal just strong enough to sense a RFID tag in a small sensing volume at a first frequency. The interrogator then determines at 58 whether any new tags have been read. If a tag is found at 60 the interrogator indicates a tag has been found. If no tags are found or not all tags have been found then polling continues at 62. At 62 the RFID interrogator signal is automatically increased so as to increase the read sensing volume. If the inventory operation or new tag data is not timed out at 64 and 66, the hardware trigger has not been released at 68, and the application has not stopped at 70, then at 56 the RFID interrogator will read RFID tags in the increased sensing volume. This operation will repeat until at 70 the application indication is to stop. If not all tags have been found at 62 and after a certain time interval then the RFID interrogator will hop to another frequency repeating the steps 56 through 70 until all desired tags have been identified. At 72 the software terminates the painting after an interval when there are no new tags found at 66 or the inventory operation has timed out. The software may terminate painting without deactivating the trigger control at 68.

In indicating a new tag has been read at 60, the indication may be actuating an audible tone at beeper 24 and/or actuating the LED 17 or 17a (FIG. 1) to provide a visual indicator.

There are various read terminations sequences including steps or events 62, 64, 66, 68 and 70. A read at step 62 may terminate when all the tags have been read. A read at 64 may terminate when the operation is timed out. The timer is started at step 54 or 56 and runs continuously as the RFID tags are interrogated. This timeout may be programmable and set to different values. The value may depend on system requirements such as reducing power consumption. The value may be variably adjusted by the system based on criteria such as average RFID signal strength, singulation, polling and frequency hopping. A read at step 66 may terminate when there is a tag timeout. This timer is restarted at step 60 each time a new tag is detected as being read. This timeout may also be programmable and set to different values depending on the system requirement for reducing power consumption. The value may be variably adjusted by the system based on criteria such as average RFID signal strength, singulation, polling and frequency hopping. At step 68 a read is terminated when the trigger is released. Finally, at step 70 a read is terminated when instructed by the inventory command algorithm. The multiple termination events 62, 64, 66, 68 and 70 may be re-arranged or omitted depending on the application.

In one embodiment of a software mechanism, there is an algorithm for decreasing operating time that may be provided by the steps of: 1) configuring the automatic inventory command for excluding protocols and antennas; and 2) polling the RFID tags during the painting at a frequency for identifying the tags.

In an alternate embodiment of the software mechanism, there is an algorithm for decreasing operating time that may be provided by the steps of: 1) configuring the automatic inventory command for excluding protocols and antennas; 2) adjusting a search order for singulating RFID tags; and 3) hopping to another frequency when the RFID tags are not located.

In still another embodiment of the software mechanism, there is an algorithm for decreasing operating time that may be provided by the steps of: 1) polling the RFID tags during the painting at a frequency for identifying the tags; and 2) hopping to another frequency when the RIFD tags are not located.

In another alternate embodiment of the software mechanism, there is an algorithm for decreasing operating time that may be provided by the steps of: 1) adjusting a search order for singulating RFID tags; 2) polling the RFID tags during the painting at a frequency for identifying the tags; and 3) hopping to another frequency when the RIFD tags are not located.

In another embodiment of the software mechanism, there is an algorithm for decreasing operating time that may be provided by the steps of: 1) adjusting a search order for singulating RFID tags; and 2) hopping to another frequency when the RIFD tags are not located.

In yet another alternate embodiment of the software mechanism, there is an algorithm for decreasing operating time that may be provided by the step of configuring the automatic configuring the automatic inventory command for excluding protocols and antennas.

In one embodiment, there is a method of saving power in a data reader or multi-technology data reader including the steps of: 1) selecting one or more software mechanisms (algorithms) for decreasing operating time of the reader; 2) activating a trigger control of the reader for engaging power to begin painting RFID tags; and 3) terminating the painting after an interval when there are no new tags without deactivating the trigger control.

In another embodiment, there is a method of saving power in a data reader or multi-technology data reader including the steps of: 1) configuring said reader for excluding protocols and antennas; 2) selecting one or more software mechanisms (algorithms) for decreasing operating time of the reader; 3) activating a trigger control of the reader for engaging power to begin painting RFID tags; and 4) terminating the painting after an interval when there are no new tags without deactivating the trigger control.

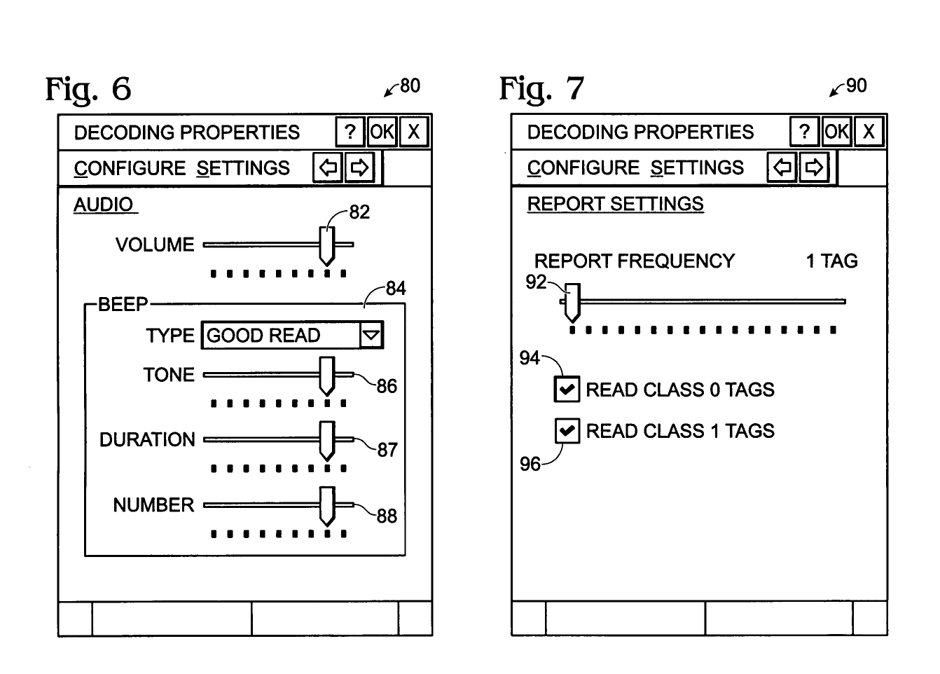

FIG. 6 illustrates a screen shot 80 of display 13 showing an input scheme for selecting the audio indicators. A volume slide button 82 enables the user to select a “beep” volume from zero to a maximum. There are several audible indicators and each are adjustable, being selected by the drop-down menu 84. The “Good Read” type is shown whereby others may include “All Tags Read” type as from step 62. Once a type 84 is selected, the tone may be selected by slide button 86. The “beep” duration may be selected by slide button 87 and the number of “beeps” may be selected by the slide button 88. For example, a triple beep may be sounded to indicate that all tags have been read.

FIG. 7 illustrates a screen 90 of display 13 showing an input scheme for report settings. Slide button 92 selects how often RFID tag data is reported to an application. When set to a specific number of new RFID tags the data is reported when at least the selected number of RFID tags has been read. When set at the minimum, that is one tag, each time a new RFID tag is read it is reported. When the slide button 92 is set at infinite, the data is reported only when the painting operation is complete. Selecting the checkbox 94 for Read Class 0 Tags or checkbox 96 for Read Class 1 Tags selectively enables or disables the device read each class of RFID tags. Reduced power consumption may be achieved by enabling only the class of RFID tags which will be interrogated.

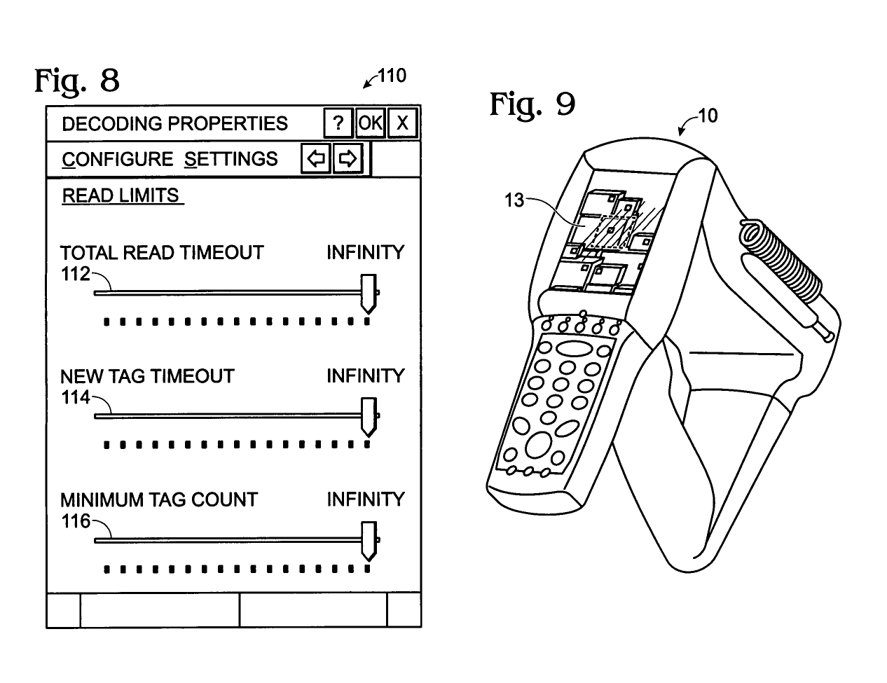

FIG. 8 illustrates screen 110 of display 13 showing an input scheme for selecting read limit values and includes the total read timeout 112, the new tag timeout 114 and the minimum tag count 116. The total read timeout 112 is the time for which the reader will be allowed to read before terminating the operation. This value corresponds to step 64 in FIG. 5. If the value is set to infinite then the reading and searching for new RFID tags will continue until the inventory command automatically ceases the operation. The inventory command ceases the operation when no new tags are found or if data collisions are not detected after a specified time at different frequencies or after hopping to a certain number of frequencies. The new tag timeout 114 is the amount of time to wait between new RFID tag reads before the inventory operation is terminated. The value corresponds to step 66 in FIG. 5. It is the maximum amount of time spent waiting for a new RFID tag to be read after the last new RFID tag that was previously read. If the value is set to infinite, then the reading and searching for new tags will continue until the inventory command automatically ceases the operation. The inventory command ceases the operation when no new tags are found or if data collisions are not detected after a specified time at different frequencies or after hopping to a certain number of frequencies. The minimum tag count 116 is the minimum number of RFID tags the interrogator will attempt to read. If set at infinite then the reading and searching for new tags will continue until the inventory command automatically ceases the operation. The inventory command ceases the operation when no new tags are found or if data collisions are not detected after a specified time at different frequencies or after hopping to a certain number of frequencies.

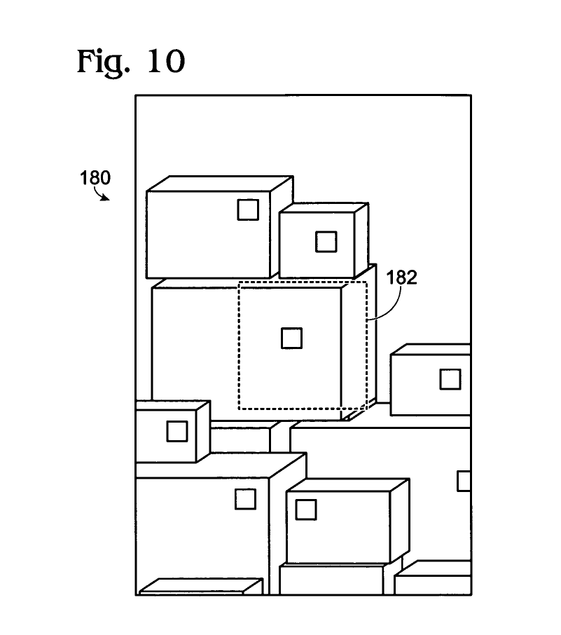

FIGS. 9 and 10 illustrate an alternate embodiment in which the unit 10 is provided with an imager and an image display. The user may select an operational mode that will configure by enabling or disabling certain protocols, antennas and/or combinations thereof. Alternately the user may select an operational mode whereby an image 180 of the field of view of the RFID reader is acquired by the imager 15 and displayed on the display screen 13. The image 130 may be larger than the effective read zone of the RFID reader. However, the display screen 13 may further provide feedback of the effective read region such as an outline of the effective read zone 182.

While there has been illustrated and described with reference to certain embodiments, it will be appreciated that numerous changes and modifications are likely to occur to those skilled in the art. It is intended in the appended claims to cover all those changes and modifications that fall within the spirit and scope of this disclosure and should, therefore, be determined only by the following claims and their equivalents.

What is claimed is:

1. A method of reducing power consumption in an electronic tag reader comprising the steps of:
configuring said reader for excluding protocols and antennas;
selecting a software mechanism for automatically decreasing operating time of said reader;
activating a trigger control of said reader for engaging power to begin painting RFID tags;
deactivating said trigger control terminating said painting after an interval when there are no new tags.

2. A method according to claim 1, wherein said software mechanism initiates frequency hopping during said painting.

3. A method according to claim 2, wherein said frequency hopping terminates automatically when there are no more tags.

4. A method according to claim 1, wherein said software mechanism initiates polling during said painting, said polling performed at a plurality of duty cycle values below 100%.

5. A method according to claim 4, wherein said polling is automatically terminated after a time interval.

6. A method according to claim 1, wherein said software mechanism initiates a search order prior to said painting.

7. A method according to claim 1, wherein said software mechanism initiates singulation during said painting.

8. A method of reducing power consumption in an electronic tag reader comprising the steps of:
configuring said reader for excluding protocols and antennas;
selecting a manual mechanism for decreasing operating time of said reader;
activating a trigger control of said reader for engaging power to begin painting RFID tags;
deactivating said trigger control terminating said painting after an interval when there are no new tags.

9. A method according to claim 8, wherein said software mechanism initiates frequency hopping during said painting.

10. A method according to claim 9, wherein said frequency hopping terminates automatically when there are no more tags.

11. A method according to claim 8, wherein said software mechanism initiates polling during said painting, said polling performed at a plurality of duty cycle values below 100%.

12. A method according to claim 11, wherein said polling is automatically terminated after a time interval.

13. A method according to claim 8, wherein said software mechanism initiates a search order prior to said painting.

14. A method according to claim 8, wherein said software mechanism initiates singulation during said painting.

15. A method of reducing power consumption in an electronic tag reader comprising the steps of:
selecting a software mechanism for decreasing operating time of said reader;
activating a trigger control of said reader for engaging power to begin painting RFID tags;
deactivating said trigger control terminating said painting after an interval when there are no new tags.

16. A method according to claim 15, wherein said software mechanism initiates frequency hopping during said painting.

17. A method according to claim 16, wherein said frequency hopping terminates automatically when there are no more tags.

18. A method according to claim 15, wherein said software mechanism initiates polling during said painting, said polling performed at a plurality of duty cycle values below 100%.

19. A method according to claim 18, wherein said polling is automatically terminated after a time interval.

20. A method according to claim 15, wherein said software mechanism initiates a search order prior to said painting.

21. A method according to claim 15, wherein said software mechanism initiates singulation during said painting.

22. A method according to claim 15, wherein said software mechanism initiates a preselection mechanism prior to said painting.

23. A method of reducing power consumption in an electronic tag reader comprising the steps of:
selecting a manual mechanism for decreasing operating time of said reader;
activating a trigger control of said reader for engaging power to begin painting RFID tags;
deactivating said trigger control terminating said painting after an interval when there are no new tags.

24. A method according to claim 23, wherein said software mechanism initiates frequency hopping during said painting.

25. A method according to claim 24, wherein said frequency hopping terminates automatically when there are no more tags.

26. A method according to claim 23, wherein said software mechanism initiates polling during said painting, said polling performed at a plurality of duty cycle values below 100%.

27. A method according to claim 26, wherein said polling is automatically terminated after a time interval.

28. A method according to claim 23, wherein said software mechanism initiates a search order prior to said painting.

29. A method according to claim 23, wherein said software mechanism initiates singulation during said painting.

30. A method according to claim 23, wherein said software mechanism initiates a preselection mechanism prior to said painting.

31. A data reader comprising:
a) a radio frequency identification (RFID) interrogator within said data reader for detecting data;
b) a processor connected to an output of said RFID interrogator;
c) a feedback mechanism connected to said output;
d) a preselection mechanism for configuring protocols and antennas;
and
e) a software mechanism for decreasing operating time of said reader.

32. The data reader according to claim 31, wherein said software mechanism is a frequency hopping algorithm used during painting that terminates automatically when there are no new tags.

33. The data reader according to claim 31, wherein said software mechanism is a polling algorithm performed at a plurality of duty cycle values below 100%.

34. The data reader according to claim 33, wherein said polling algorithm is automatically terminated after a time interval.

35. The data reader according to claim 31, wherein said software mechanism is an automatically adjusted search order algorithm.

36. The data reader according to claim 31, wherein said software mechanism is a singulation algorithm.

37. A multiple technology data reader comprising:
a) a housing;
b) an optical data reader;
c) a radio frequency identification (RFID) interrogator for detecting data;
d) a communications unit connected to said optical data reader and said RFID interrogator;
e) a preselection mechanism for configuring protocols and antennas; and
f) a software mechanism for decreasing operating time of said reader.

38. The data reader according to claim 37, wherein said software mechanism is a frequency hopping algorithm used during painting that terminates automatically when there are no new tags.

39. The data reader according to claim 37, wherein said software mechanism is a polling algorithm performed at a plurality of duty cycle values below 100%.

40. The data reader according to claim 39, wherein said polling algorithm is automatically terminated after a time interval.

41. The data reader according to claim 37, wherein said software mechanism is an automatically adjusted search order algorithm.

42. The data reader according to claim 37, wherein said software mechanism is a singulation algorithm.

43. The data reader according to claim 37, wherein said software mechanism is a preselection mechanism algorithm.

44. A data reader comprising:
a) a radio frequency identification (RFID) interrogator within said data reader for detecting data;
b) a processor connected to an output of said RFID interrogator;
c) a feedback mechanism connected to said output; and
d) a software mechanism for decreasing operating time and power consumption of said data reader.

45. The data reader according to claim 44, wherein said software mechanism is a frequency hopping algorithm used during painting that terminates automatically when there are no new tags.

46. The data reader according to claim 44, wherein said software mechanism is a polling algorithm performed at a plurality of duty cycle values below 100%.

47. The data reader according to claim 46, wherein said polling algorithm is automatically terminated after a time interval.

48. The data reader according to claim 44, wherein said software mechanism is an automatically adjusted search order algorithm.

49. The data reader according to claim 44, wherein said software mechanism is a singulation algorithm.

50. The data reader according to claim 44, wherein said software mechanism is a preselection mechanism algorithm.

51. A multiple technology data reader comprising:
a) a housing;
b) an optical data reader;
c) a radio frequency identification (RFID) interrogator for detecting data;
d) a communications unit connected to said optical data reader and said RFID interrogator; and
e) a software mechanism for decreasing operating time and power consumption of said multiple-technology data reader.

52. The data reader according to claim 51, wherein said software mechanism is a frequency hopping algorithm used during painting that terminates automatically when there are no new tags.

53. The data reader according to claim 51, wherein said software mechanism is a polling algorithm performed at a plurality of duty cycle values below 100%.

54. The data reader according to claim 53, wherein said polling algorithm is automatically terminated after a time interval.

55. The data reader according to claim 51, wherein said software mechanism is an automatically adjusted search order algorithm.

56. The data reader according to claim 51, wherein said software mechanism is a singulation algorithm.

57. The data reader according to claim 51, wherein said software mechanism is a preselection mechanism algorithm.

58. A data reader comprising:
a) a radio frequency identification (RFID) interrogator within said data reader for detecting data;
b) a processor connected to an output of said RFID interrogator;
c) a feedback mechanism connected to said output; and
d) a manual mechanism for decreasing operating time and power consumption of said data reader.

59. The data reader according to claim 58, wherein said manual mechanism initiates frequency hopping used during painting, said hopping automatically terminates when there are no new tags.

60. The data reader according to claim 58, wherein said manual mechanism initiates polling, said polling performed at a plurality of duty cycle values below 100%.

61. The data reader according to claim 60, wherein said polling is automatically terminated after a time interval.

62. The data reader according to claim 58, wherein said manual mechanism initiates an automatically adjusted search order.

63. The data reader according to claim 58, wherein said manual mechanism initiates singulation.

64. The data reader according to claim 58, wherein said manual mechanism initiates a preselection mechanism.

65. A multiple technology data reader comprising:
a) a housing;
b) an optical data reader;
c) a radio frequency identification (RFID) interrogator for detecting data;
d) a communications unit connected to said optical data reader and said RFID interrogator; and
e) a manual mechanism for decreasing operating time and power consumption of said multiple-technology data reader.

66. The data reader according to claim 65, wherein said manual mechanism initiates frequency hopping used during painting, said hopping automatically terminates when there are no new tags.

67. The data reader according to claim 65, wherein said manual mechanism initiates polling, said polling performed at a plurality of duty cycle values below 100%.

68. The data reader according to claim 67, wherein said polling is automatically terminated after a time interval.

69. The data reader according to claim 65, wherein said manual mechanism initiates an automatically adjusted search order.

70. The data reader according to claim 65, wherein said manual mechanism initiates singulation.

71. The data reader according to claim 65, wherein said manual mechanism initiates a preselection mechanism.
